(19) United States
(12) Patent Application Publication
(10) Pub. No.: US 2017/0209810 A1
(43) Pub. Date: Jul. 27, 2017

(54) SYSTEM AND METHOD FOR MANIPULATION OF ION CONCENTRATION TO MAXIMIZE EFFICIENCY OF ION EXCHANGE

(71) Applicant: Kurion, Inc., Irvine, CA (US)

(72) Inventors: Joshua MERTZ, West Richland, WA (US); Brett SIMPSON, Richland, WA (US); Ja-Kael LUEY, Richland, WA (US); Ron ORME, West Richland, WA (US); David CARLSON, Oak Ridge, TN (US)

(73) Assignee: Kurion, Inc., Irvine, CA (US)

(21) Appl. No.: 15/414,320

(22) Filed: Jan. 24, 2017

Related U.S. Application Data
(60) Provisional application No. 62/286,927, filed on Jan. 25, 2016.

(51) Int. Cl. B01D 15/12; B01D 61/02; B01J 47/14; C02F 1/42; C02F 1/44; B01D 15/36; B01D 9/00

(52) U.S. Cl. CPC B01D 15/125; B01D 15/361; B01D 61/027; B01D 61/025; B01D 9/0018; C02F 1/42; B01D 15/12; C02F 1/441; C02F 1/442; B01J 47/14; B01D 2311/2623

(57) ABSTRACT

A method for manipulating ion concentration to maximize ion exchange media performance is disclosed herein. First a source liquid is directed through an ion concentrator such as a nanofilter, reverse osmosis membrane, or an evaporator/crystallizer. The ion concentrator separates the source liquid into a concentrate stream and a permeate stream wherein the permeate stream comprises a smaller concentration of ions than the concentrate stream. The concentrate stream and/or the permeate stream (input stream) may then be directed through an ion exchange vessel. The ion exchange vessel receives the input stream, enables ion exchange between the ion exchange media in the vessel and the input stream resulting in a liquid output having a smaller concentration of ions than the input stream.

### CROSS-REFERENCE TO RELATED APPLICATIONS

The following disclosure relates to U.S. Provisional Application 62/286,927, filed Jan. 25, 2016 entitled SYSTEM AND METHOD FOR MANIPULATION OF ION CONCENTRATION TO MAXIMIZE EFFICIENCY OF ION EXCHANGE MATERIALS, which is herein incorporated by reference in its entirety, and to which the present application also claims priority; co-pending application MOBILE PROCESSING SYSTEM FOR HAZARDOUS AND RADIOACTIVE ISOTOPE REMOVAL, Ser. No. 14/748,535 filed Jun. 24, 2015 with a priority date of Jun. 24, 2014, which is herein incorporated by reference in its entirety; co-pending patent application HELICAL SCREW ION EXCHANGE AND DESICCATION UNIT FOR NUCLEAR WATER TREATMENT SYSTEMS, Ser. No. 15/136,600 filed Apr. 22, 2016 with a priority date of Apr. 24, 2015, which is herein incorporated by reference in its entirety; co-pending patent application ISM MEDIA REMOVAL FROM VESSEL FOR VITRIFICATION, Ser. No. 15/012,101 filed on Feb. 1, 2016 with a priority date of Feb. 1, 2015, which is herein incorporated by reference in its entirety; and co-pending application ADVANCED TRITIUM SYSTEM AND ADVANCED PERMEATION SYSTEM FOR SEPARATION OF TRITIUM FROM RADIOACTIVE WASTES, Ser. No. 15/171,183 filed on Jun. 2, 2016 with a priority date of Oct. 9, 2015, which is herein incorporated by reference in its entirety.

### TECHNICAL FIELD OF THE INVENTION

This disclosure relates generally to the manipulation of ion concentration to dynamically manage performance of ion exchange systems and processes.

### BACKGROUND

Most existing mobile water processing systems are comprised of merely one specific process, or multiple processes within a single transportable module. Sites requiring waste water remediation are diverse in their specific requirements, topography, and the location. Natural disaster, terrorist attacks, and malfunctions often require rapid deployment of aid to mitigate overall damage to the environment and adverse effect to people living in the region surrounding the site. Current water remediation systems are not sufficient to perform this task. What is needed is a highly mobile, easily transportable, scalable, modular, easily deployable (often within 24 hours depending on site location, topography, and remediation requirements) and cost-effective system that can also be utilized to manipulate ion concentration and maximize ion exchange efficiency. The system may be highly adaptable to differing remediation requirements, scalable to maximize efficiency, and modular to perform all remediation needs including outputting water within safety standards as well as processing the removed contaminants to final disposition standards.

So as to reduce the complexity and length of the Detailed Specification, and to fully establish the state of the art in certain areas of technology, Applicant(s) herein expressly incorporate(s) by reference all of the following publications identified below. Applicant(s) expressly reserve(s) the right to swear behind any of the incorporated materials.

U.S. Provisional Application 62/286,927, filed Jan. 25, 2016 entitled SYSTEM AND METHOD FOR MANIPULATION OF ION CONCENTRATION TO MAXIMIZE EFFICIENCY OF ION EXCHANGE MATERIALS, which is herein incorporated by reference in its entirety, and to which the present application also claims priority.

Mobile Processing System for Hazardous and Radioactive Isotope Removal, Ser. No. 14/748,535 filed Jun. 24, 2015, with a priority date of Jun. 24, 2014, which is herein incorporated by reference in its entirety.

Helical Screw Ion Exchange and Desiccation Unit for Nuclear Water Treatment Systems, Ser. No. 15/136,600 filed on Apr. 22, 2016 with a priority date of Apr. 24, 2015, which is herein incorporated by reference in its entirety.

ISM Media Removal from Vessel for Vitrification, Ser. No. 15/012,101 filed on Feb. 1, 2016 with a priority date of Feb. 1, 2015, which is herein incorporated by reference in its entirety.

Advanced Tritium System and Advanced Permeation System for Separation of Tritium from Radioactive Wastes, Ser. No. 15/171,183 filed on Jun. 2, 2016 with a priority date of Oct. 9, 2015, which is herein incorporated by reference in its entirety.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

Aspects and applications presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the systems, methods, processes, and/or apparatuses disclosed herein. To the contrary, if the provisions of 35 U.S.C. §112, ¶6 are sought to be invoked to define the embodiments, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ”, if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed embodiments, it is intended that the embodiments not be limited only to the specific structure, material or acts that are described in the preferred embodiments, but in addition, include any and all structures, materials or acts that perform the claimed function as described in alternative embodiments or forms, or that are well known present or later-developed, equivalent structures, material or acts for performing the claimed function.

### BRIEF DESCRIPTION OF THE FIGURES

A more complete understanding of the systems, methods, processes, and/or apparatuses disclosed herein may be derived by referring to the detailed description when considered in connection with the following illustrative figures. In the figures, like-reference numbers refer to like-elements or acts throughout the figures.

FIG. 1 depicts a typical breakthrough curve.

FIG. 2 is a graph depicting the relationship between the concentrations of influent ions to the capacity of the media without a concentration step.

FIG. 3A depicts the concentration of influent ions and the capacity of the media with and without a concentration step when all ions in the liquid are concentrated equally.

FIG. 3B is a graph showing a comparison between the concentrations of influent ions to the capacity of the media with and without a concentration step wherein the concentration step results in higher concentration of one ion with respect to the other ions in the liquid.

FIG. 3C is the graph of FIG. 3B wherein the concentration step also increases the capacity of the media.

FIG. 4 depicts the movement of the curve to achieve maximum capacity as the concentration step increases the ion to the ion exchange (IX) media.

FIG. 5 depicts an exemplary nanofilter.

FIG. 6 is an isometric view of an example embodiment Mobile Processing System (MPS) comprising five separate skids.

FIG. 7 is a top view of the example embodiment of FIG. 6.

FIG. 8 depicts an example configuration of MPS skids.

FIG. 9 depicts the MPS configuration of FIG. 8 with the addition of a Nanofiltration skid.

FIG. 10 depicts the MPS configuration of FIG. 9 with the addition of an ISM skid for processing of the permeate stream.

FIG. 11 depicts two possible storage configurations comprising of a Permeate Collection Tank and a Concentrate Collection Tank.

FIG. 12A depicts an embodiment of a nanofiltration step.

FIG. 12B depicts the embodiment of FIG. 12A with example flow rates and tank volumes.

FIG. 13 depicts an embodiment that includes a precipitation process.

FIG. 14 depicts an embodiment that includes a metal hydroxide precipitation process.

Elements and acts in the figures are illustrated for simplicity and have not necessarily been rendered according to any particular sequence or embodiment.

### DESCRIPTION

In the following description, and for the purposes of explanation, numerous specific details, process durations, and/or specific formula values are set forth in order to provide a thorough understanding of the various aspects of exemplary embodiments. It will be understood, however, by those skilled in the relevant arts, that the apparatus, systems, and methods herein may be practiced without these specific details, process durations, and/or specific formula values. It is to be understood that other embodiments may be utilized and structural and functional changes may be made without departing from the scope of the apparatus, systems, and methods herein. In other instances, known structures and devices are shown or discussed more generally in order to avoid obscuring the exemplary embodiments. In many cases, a description of the operation is sufficient to enable one to implement the various forms, particularly when the operation is to be implemented in software. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized and structural and functional changes may be made without departing from the scope.

### Ion Exchange and Ion Concentration Overview

Ion exchange (IX) materials operate on the conditions of equilibrium between ions in solution and ions in the media, such that if a particular ion in the solution is not in the media, there is a dynamic where a percentage of the ion will enter into the material creating equilibrium.

Ion exchange materials have varying capacities for ions, meaning that there is limited space for a given ion in the material. This varying capacity in operation can be termed the “effective capacity” and should approach the theoretical capacity of the material. All IX media contain counter ions, such as (H⁺) or (OH⁻) that are exchanged when the material comes in contact with other ions (such as Na⁺, Ca²⁺, Cl⁻, etc.). The extent of the exchange is a function of the material itself, the physical conditions of the solution, and the concentration of ions in the solution. The equilibrium between an IX media and any given ion, X, is dependent on the concentration of that ion (X) in solution and other ions that may compete with it for IX sites. When there is a low concentration of X in solution, the equilibrium forces are weak, and the capacity of the media will be lower than the maximum theoretical capacity. When there are other ions in solution, mass action can help drive ion X into the media, or other ions (Y, Z, etc.) may compete with ion X for sites.

In using concentration technologies such as nanofiltration, reverse osmosis, and evaporation the total concentration of the ion X will increase. This increases the driving force for X to be sorbed by the IX material allowing the “effective capacity” of the media to more closely approach the theoretical capacity. In some embodiments, the addition of a concentration step prior to ion exchange increases the rate of reaction in the ion exchange media thus increasing the operating efficiency of the media by reducing processing time. For the nanofilter option, chemicals can be added such that the nanofilter selectively concentrates one ion (or group of ions) over another ion (or group of ions). For example, it can increase the strontium concentration by four times in the concentrate stream while the sodium concentration remains the same, in some embodiments. The ratio of ion X to ion Y may be increased, such that the driving force to reach equilibrium is increased by reducing the relative competition from Y. For a reverse osmosis system, concentration can be controlled using other methods, but in general, the concentrations of all ions may be increased at the same factor. This results not in a better ratio of X to Y, but an overall ionic driving force in the equilibrium system by mass action. Evaporation methods work in a similar manner as reverse osmosis systems.

This concept can be applied in any treatment of solutions containing ions, and in which a sorption material (IX, adsorption, or absorption material) is used. The adsorption or absorption materials may work in a similar manner, however in a different mechanism. This concept is primarily used to optimize loading of a target ion, or species, on a material and to reduce overall waste generation. In some embodiments the performance of the media is determined by the amount of waste produced wherein a smaller amount of waste is indicative of better performance.

### Breakthrough Curves

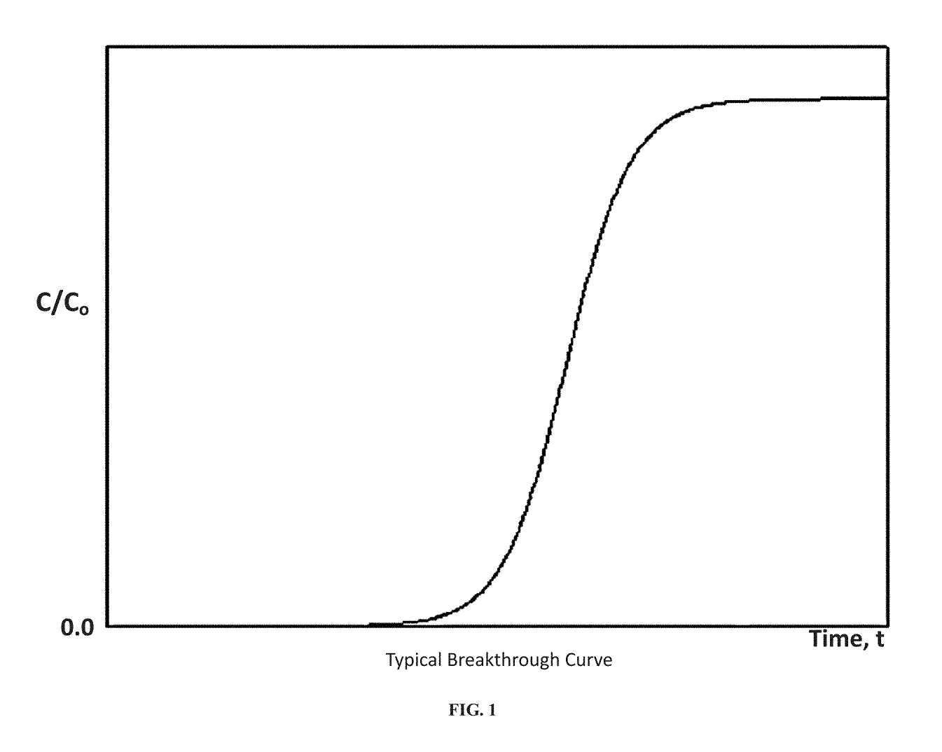

FIG. 1 depicts a typical breakthrough curve that is plotted as final concentration (C) (effluent) divided by initial concentration (C₀) (influent) with respect to time (t), as depicted, or volume (v). This represents a normalization of the ions with respect to concentration. The steepness of the breakthrough curve determines the extent to which the capacity of a sorbent bed can be utilized. Thus, the shape of the curve is instrumental in determining the length of the sorption bed. When the curve is plotted with respect to time (t) a steeper curve indicates a quicker reaction which is indicative of improved operating efficiency. Improving operating efficiency allows for a larger volume to be processed in a shorter amount of time.

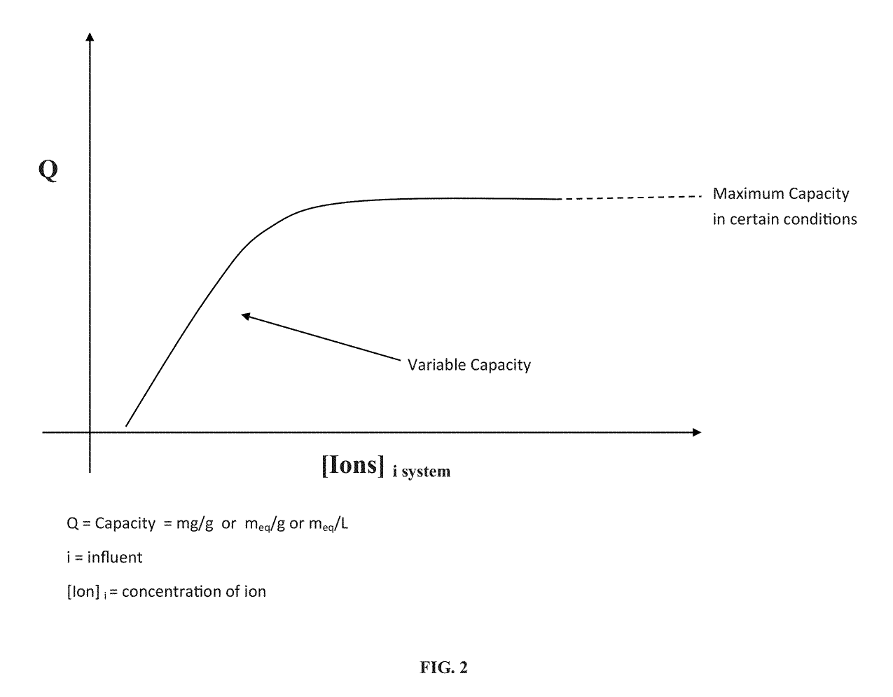

FIG. 2 depicts the relationship between the ion concentration and the capacity of the media. The performance of ion exchange media in a column or batch mode is dependent on the total ion concentration in the solution, the ion to be separated, and the other ions that are competing with it. An ion exchange media also has a maximum theoretical capacity (defined in m_{eq}/g or m_{eq}/L), which can only be met under certain conditions. In normal operating conditions, this capacity is rarely met due to competition between ions; this is considered the “active” capacity of the medium. Based on an Adsorption Isotherm Model, the maximum capacity of a media can be reached when the concentrations of the target ions are high; the total capacity decreases when the concentrations are low. Given these facts, concentration techniques can be employed to increase the “active” capacity of media.

There are at least three technologies which can be used to concentrate ions in solution: nanofiltration, reverse osmosis, and evaporation/crystallization. In each of these technologies there is a concentrate stream whereby ions are concentrated as portion of the total solution and a permeate, or discharge, stream which has significantly reduced ion concentrations. The concentrate stream is the portion of the liquid containing a greater concentration of ions after processing. In nanofiltration and reverse osmosis the concentrate stream is the portion of the liquid that does not pass through the membrane. In evaporation the concentrate stream is the portion of the liquid that is not evaporated. The permeate stream is the portion of the liquid containing a smaller concentration of ions after processing. In nanofiltration and reverse osmosis the permeate stream is the portion of the liquid that passes through the membrane. In evaporation the permeate stream is the portion of the liquid that is evaporated. “Permeate” as used herein specifically refers to the permeate stream that is produced by one or more ion concentration technologies.

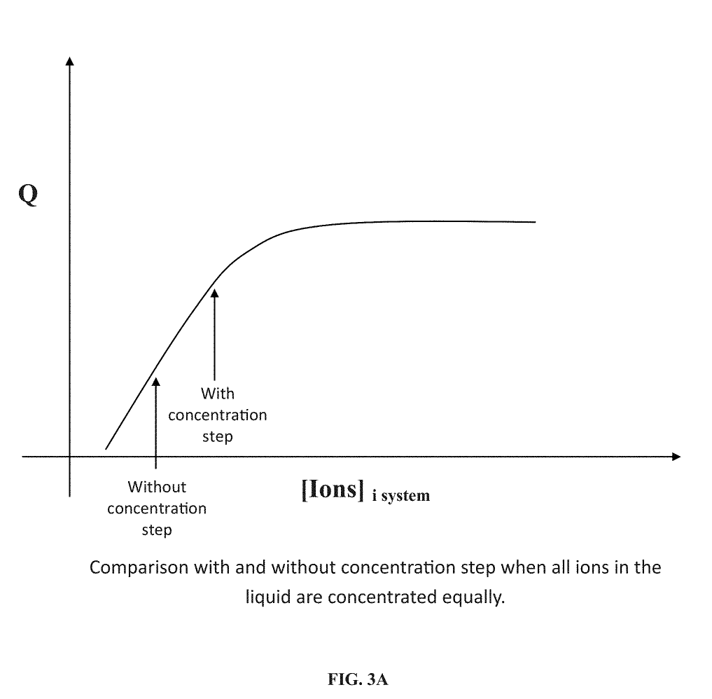

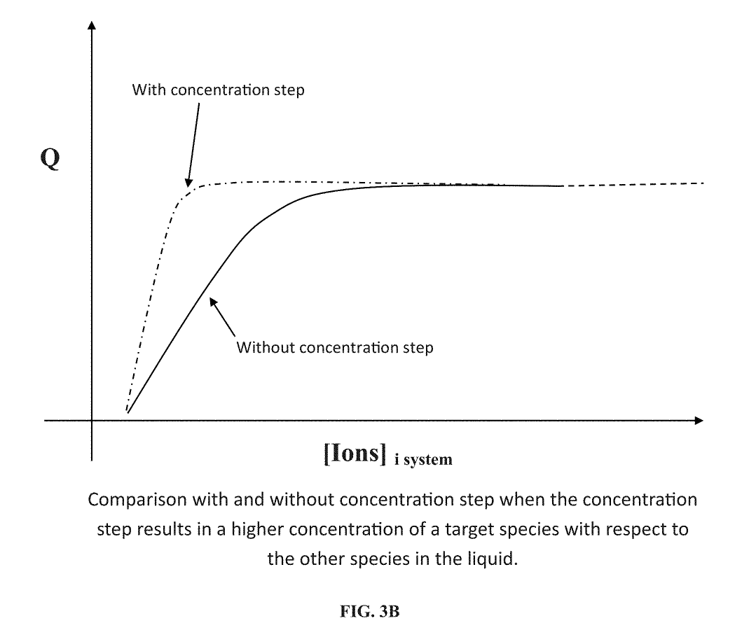

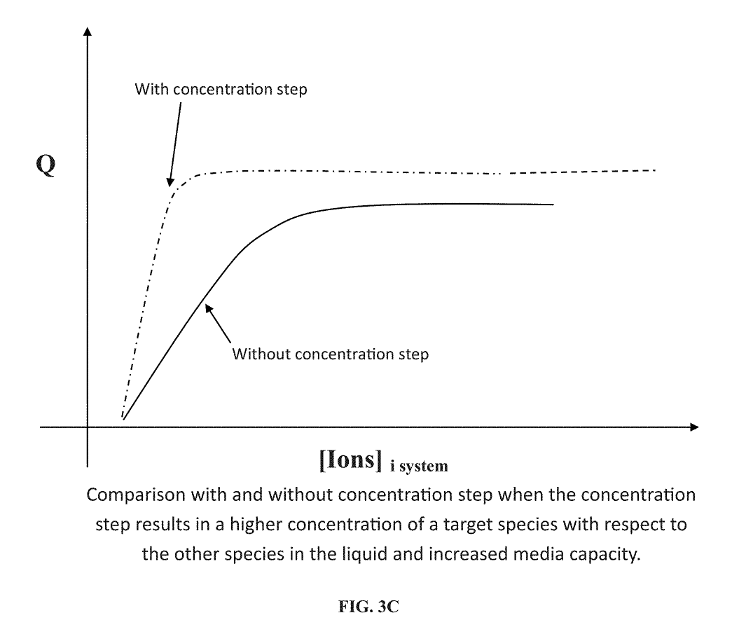

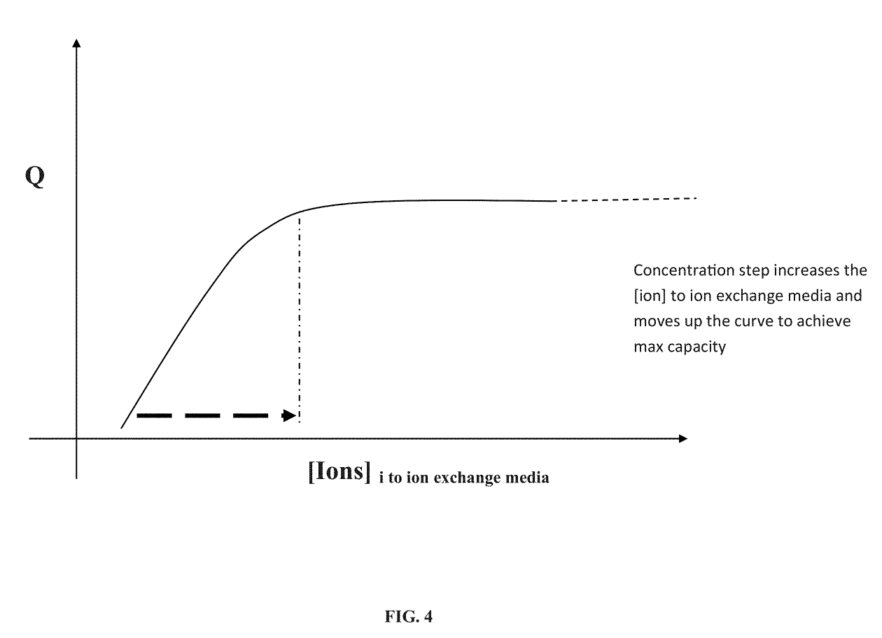

The manipulation of ion concentration can be used to maximize uptake on the media. The use of one or more ion concentration technologies to increase multivalent ion concentration to cation media improves its performance. FIGS. 3A through 3C graphically depict the capacity of the media in relation to the ion concentration and the difference between the use of a concentration step and without a concentration step. FIG. 3A is a graph showing the concentration of influent ions to the capacity of the media with and without a concentration step when all ions in the liquid are concentrated equally. FIG. 3B is a graph showing a comparison between the concentrations of influent ions to the capacity of the media with and without a concentration step wherein the concentration step results in higher concentration of one ion with respect to the other ions in the liquid. FIG. 3C is the graph of FIG. 3B wherein the concentration step also increases the capacity of the media. When a first set of ions X is concentrated by a factor of A, and a second set of ions Y is concentrated by a different set of factors B (wherein B is less than A) the effective capacity of the media to retain X is increased. FIG. 4 shows the upward movement of the curve to achieve maximum capacity of the media and a concentration step increases the ion to ion exchange (IX) media.

### Nanofiltration

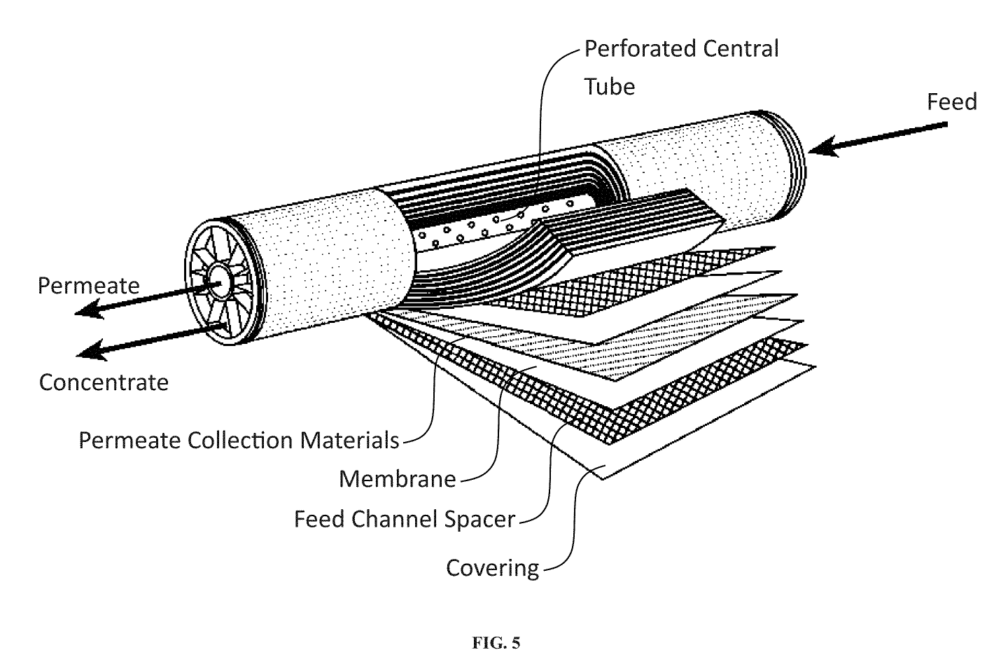

In some embodiments a nanofilter conditioning step is used to increase the concentration of one or more select target species (e.g. magnesium, calcium, and strontium, among others) and improve the utilization of the ion exchange media. FIG. 5 shows an isometric view of an exemplary nanofilter. Nanofiltration is a separation process that utilizes diffusion through a membrane with a typical pore size between 0.1 to 10 nanometers. Unlike reverse osmosis membranes, nanofilter membranes operate at lower pressure and offer selective solute rejection based on size. The pressure differential between the two sides of the membrane facilitates the nanofiltration process.

Application of a nanofilter creates a concentrate stream with greater concentration of target species (e.g., magnesium, calcium, and strontium) while allowing monovalent species to pass to the permeate stream. In some embodiments, the media loading capacity increases as the concentration of the select target species increases. Preliminary testing of the concentrate stream composition did not show significant difference in loading capacity from the reduced ratio of multivalent to monovalent ions.

Table 1 shows preliminary analyses that illustrate an example embodiment wherein the ion exchange media loading capacity is a function of magnesium concentration. As magnesium concentration increases, so does the loading capacity. A similar effect can be achieved for other target species such as calcium and strontium, among others.

TABLE 1
Effect of Mg Concentration on Media Capacity

| Removal Cycle | Magnesium, | Media Capacity |
|---|---|---|
| Step # | ppm | mg/kg media |
| 0 | 1400 | 24.22 |
| 1 | 1359 | 24.03 |
| 2 | 1319 | 23.86 |
| 3 | 1280 | 23.69 |
| 63 | 218 | 19.02 |
| 64 | 212 | 18.99 |
| 65 | 206 | 18.96 |
| 66 | 199 | 18.93 |

In some embodiments the nanofilter is a 5:3:2 tube array. In some embodiments the nanofilter elements are eight inches in diameter and forty inches in length. In some embodiments there are six elements per tube. In some embodiments, the tubes may be twenty-one feet long. In some embodiments the Nanofilter skid comprises a three stage array and associated equipment and may be contained within a single enclosure. Other configurations are possible and considered.

In some embodiments more than one nanofilter, or array of nanofilters, may be used where each nanofilter, or array of nanofilters, is implemented to concentrate a specific target species in the liquid. In some embodiments one or more nanofilters or nanofilter arrays may be mounted in one or more mobile skids. In some embodiments one or more Nanofilter skids may be used wherein each skid may contain one or more nanofilters and wherein each skid is operable to concentrate a specific target species in the liquid. In some embodiments one Nanofilter skid may be used wherein the Nanofilter skid comprises one or more nanofilters each operable to concentrate a different target species in the liquid.

With respect to projected life for the nanofilter membranes, a properly designed system (which requires defined and consistent source liquid chemistry at the inlet) can operate for many years without cleaning. Aspects which are considered include maintaining a membrane flux within acceptable range, flow on the concentrate side within acceptable range, and liquid chemistry managed to minimize solids formation. Typically, a clean-in-place system may be provided with the nanofilter to address unexpected changes in the liquid chemistry. The specific chemicals required for the cleaning may be dependent on the projected spikes in the liquid chemistry and the type of scaling which might occur.

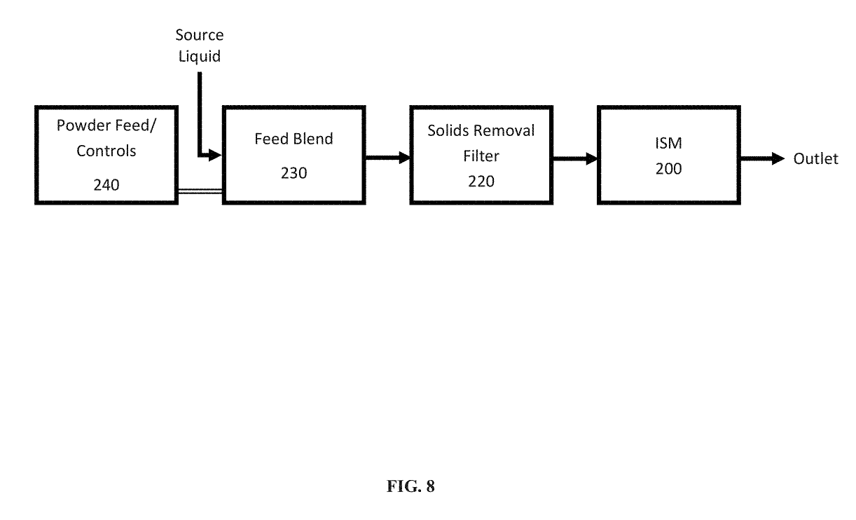

Another potential situation which may require maintenance is the presence of suspended solids that may become entrained in the nanofilter membrane. To address this situation an inline cartridge filter is typical for the incoming stream. Other filtration systems may be utilized. If significant suspended solids were projected for an embodiment, one or more Solids Removal skids 220 (FIG. 8) comprising one or more solids removal filters (SRF) may be used to reduce, or remove, the suspended solids in the process liquid. Within the membranes, accumulation of solids may be minimized by controlling chemistry and designing the system so that an acceptable flow rate is maintained on the concentrate side of the membrane.

### Reverse Osmosis

In some embodiments a reverse osmosis conditioning step is used to increase the concentration of one or more select target species (e.g. magnesium, calcium, and strontium, among others) and improve the utilization of the ion exchange media. Reverse osmosis is capable of separating granular particulate such as sand, sediment, or other suspended solids, as well as molecular compounds and ions provided their physical size is larger than that of the solvent. Application of reverse osmosis creates a concentrate stream with greater concentration of ions (e.g., magnesium, calcium, and strontium) while allowing water to pass to the permeate stream. In some embodiments, the media loading capacity increases as the concentration of the ions in the process liquid increases.

Osmosis is the spontaneous tendency for water to move concentrations across a pressure gradient of high to low. For example, if one gallon of saline water is connected to one gallon of distilled water and allowed to sit, after a period of time both gallons would contain an equal concentration of saline. The dissolved molecules will balance out across the concentration gradient of high to low, resulting in two equal midpoint concentrations. Reverse osmosis is a forcibly applied inverse of natural osmosis in which a single volume of concentrated liquid is separated into solute and solvent. The process is typically employed for the desalinization and filtering of drinking water, but can be applied to most any liquid processing operation.

In some embodiments, the process may be accomplished by employing an outside force such as a pump, gravity, moving plate, or any other means of applying a force, to the solvent, and forcing it through a semi-permeable membrane. The semi-permeable membrane contains holes or gaps large enough for the solvent to pass through while leaving the solute behind. In the example embodiment discussed above, a high saline concentration solvent is forced through a semi-permeable membrane comprised of holes large enough for H₂O molecules, but small enough to prevent Na⁺ or Cl⁻ ions from passing through. These ions are both larger than an H₂O molecule, so any amount can be filtered out of the solvent regardless of ion concentration or mass of solute present.

### Evaporation/Crystallization

Evaporation/crystallization is a treatment option that removes liquid from dissolved solids (as opposed to other options where the dissolved solids are removed from liquid). The overall ion concentration increases because the amount of ions in the liquid remains the same while the volume of the liquid decreases. Generally evaporation/crystallization systems are implemented to completely remove the liquid from the solids in solution; however, for the systems and methods disclosed herein it is beneficial to use evaporation/crystallization systems to reduce the volume of the liquid resulting in a solution having a greater concentration of ions. As discussed previously, increasing the concentration of ions in solution increases the performance of ion exchange media.

An embodiment utilizes an evaporation/crystallization system to reduce volume of source liquid thus increasing ion concentration in the liquid. This approach does not add chemicals to precipitate solids. Depending on the chemistry of the source liquid, the first step in the process may be pH adjustment and de-gassing of the liquid stream to remove bicarbonate alkalinity. This operating step may be done in three stages (acidification, de-aeration, re-alkalinization), in some embodiments, and results in a liquid stream that protects the downstream evaporator/crystallizer components from scaling.

The recirculating concentrated slurry may be taken off as a slip stream to a dewatering system to produce a 90wt % suspended solids stream, in some embodiments. The liquid recovered from dewatering the solids may be recycled through the evaporator/crystallizer and/or one or more additional evaporators and/or crystallizers, in some embodiments.

In some embodiments processing equipment may be modular. For instance, the processing equipment may be contained within a modular enclosure, or skid, much like the MPS skids. In some embodiments water treatment flow capacity is 400 m³/day (16.7 m³/hr). Other flow rate capacities and processing equipment are considered. Processing equipment for any flow rate capacity may be modular in design. In some embodiments, power consumption for the facility, with equipment, is estimated to be about 1100 kW. The power consumption is predominantly for the evaporation process and thus a function of the flow rate and not the dissolved solids content. The equipment may include one or more auxiliary boiler to produce steam for startup purposes to operate the crystallizer heater until the vapor generation is sufficient to drive the crystallizer heater.

### Mobile Processing System Overview

The processing options discussed above, and others not expressly described herein, may be mobile or modular in design. In some embodiments the systems and methods disclosed herein may be included in mobile modules such as those disclosed in co-pending application entitled Mobile Processing System (MPS) for Hazardous and Radioactive Isotope Removal, Ser. No. 14/748,535 filed Jun. 24, 2015, with a priority date of Jun. 24, 2014, which is herein incorporated by reference in its entirety.

The Mobile Processing System (MPS) is designed to be both transported and operated from standard sized intermodal containers or custom designed enclosures, referred to herein as skids or modules, for increased mobility between sites and on-site, further increasing the speed and ease with which the system may be deployed. The system may be completely modular wherein different modules perform different operations in a modular liquid remediation process. The skids may be connected in parallel and/or in series in order to perform all of the process requirements for any given site. A further advantage of the MPS is the availability of additional modules for further processing of the contaminants removed from contaminated liquids such that the contaminants do not need to be transported from the site for further processing prior to final disposition.

The MPS may comprise one or more forms of liquid processing. Depending on the needs of the particular site, one or more different processes may be used. In some embodiments, one or more of the same modules may be used in the same operation. For instance, two or more separate ion specific media (ISM) modules may be used in series and/or in parallel. In some embodiments one or more ISM modules in a series may each be operable to remove a specific ion from the waste stream. Another example is placing two or more of the same module in parallel to handle an increased flow capacity or to bring one or more modules online while one or more others are brought offline for maintenance. For processes that take more time, such as feed/blend in some embodiments, it may be advantageous to place one or more modules in parallel to reduce overall processing time. Other configuration variations not expressly disclosed herein may be implemented.

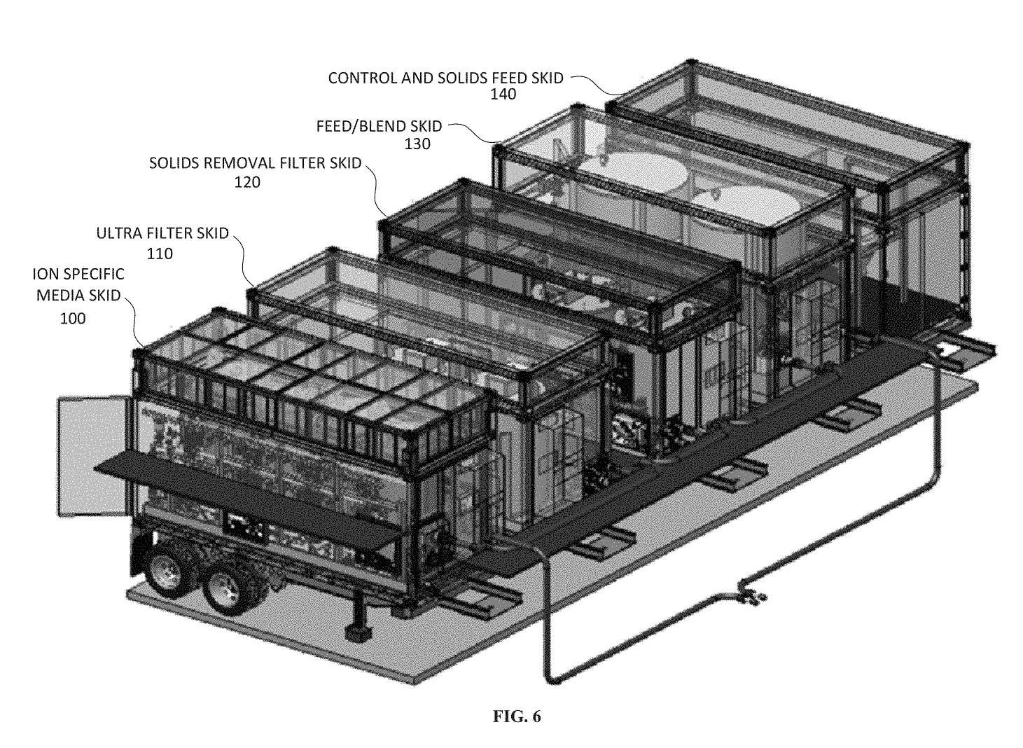

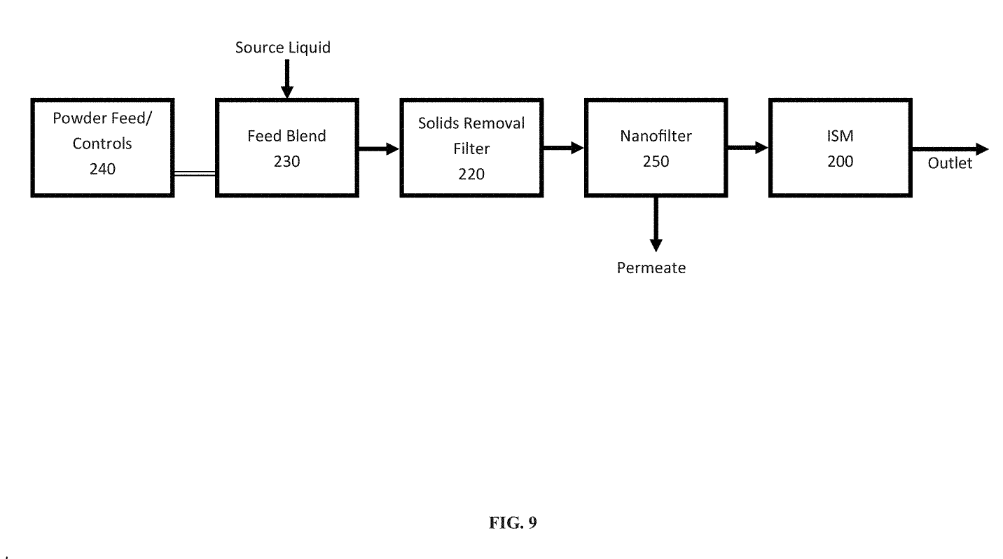

FIG. 6 is an isometric view of an embodiment of a MPS comprising five separate skids: a Control and Solids Feed skid 140, a Feed/Blend skid 130, a Solids Removal Filter skid 120, an Ultra Filter skid 110, and an Ion Specific Media (ISM) skid 100. In an embodiment, the five skids depicted in FIG. 6 can be arranged in different operation modes that allow for flexibility in accommodating specific processing needs. Some embodiments may comprise one or more types of skids not depicted in FIG. 6 such as one or more Nanofiltration skids 250 (FIG. 9), Reverse Osmosis skids (not shown), and Evaporation/Crystallization skids (not shown). Processing embodiments may comprise any number and type(s) of skids as required for the particular application.

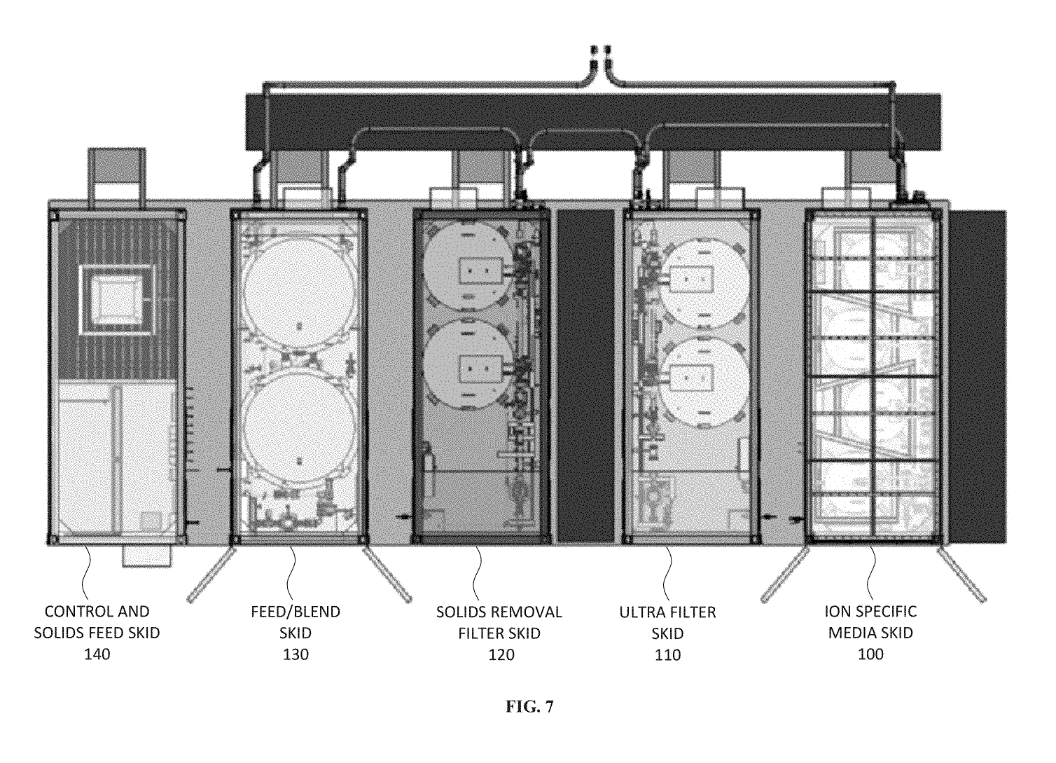

FIG. 7 is a top view of the system of FIG. 6. In an embodiment, the five skids of FIG. 6 are depicted side by side but do not necessarily have to be in this configuration on site. In an embodiment, the skids may be positioned as required by the topography of the site.

In some embodiments, to minimize the frequency for access to the skids for Ion Specific Media (ISM) vessel replacement, the equipment may be configured to use six or more ISM vessels in series, or parallel, by connection of two or more ISM modules. The determination of the number of ISM vessels required is dependent on the loading capacity of the media, the target species, and the size of the vessels. In some embodiments, the loading capacity of the media is a function of the concentration of the target species. Preliminary testing indicates higher loading capacity for higher magnesium concentration, for instance.

FIG. 8 depicts an example configuration of four MPS skids: a Powder Feed/Controls skid 240, a Feed Blend skid 230, a Solids Removal skid 220, and an ISM skid 200. The Solids Removal skid 220 with the solid removal filters may be used to protect the ion exchange columns with the aim of accounting for the potential presence of suspended solids. The ISM skid 200 may be configured to utilize one or more ISM vessels in series and/or in parallel. Some embodiments utilize more than one ISM skid 200 in series and/or in parallel. The configuration, type, and number of skids may vary between embodiments. Processing may continue until a target residual ion concentration is attained for one or more target species.

In some embodiments, the selected endpoint is magnesium removal until the residual magnesium concentration is 200 ppm or less, which may then be treated by other treatment systems, if necessary to meet certain regulations, standards, and/or requirements. The amount of media required is based on the desired end concentrations of one or more target species. In some embodiments the process liquid may be continuously cycled through the system until it meets process or other requirements. In some embodiments the process liquid may proceed to secondary processing where it may be treated by other low concentration treatment systems, if necessary to meet certain regulations, standards, and/or requirements.

The system may incorporate a number of valves. The valves may be of one or more different types. Check valves may be used through the system to prevent flow from flowing backwards. Many of the valves may be motor operated to allow for quick shutoff or open as necessary to prevent leaks or reduce pressure. Pressure relief valves may be used to automatically release pressure when the system pressure exceeds a predetermined value. Motor operated valves may be designed to fail as-is, open, or closed depending on their location in the system to minimize damage and environmental hazards in the event of failure. Redundant valves may be used throughout the system to provide additional control and increase the factor of safety of the system, reducing the possibility of leakage to the environment in the event of a failure. Valves are disclosed in more detail in co-pending application entitled Mobile Processing System for Hazardous and Radioactive Isotope Removal, Ser. No. 14/748,535 filed Jun. 24, 2015, with a priority date of Jun. 24, 2014, which is herein incorporated by reference in its entirety.

### Concentration Step Followed by MPS

In some embodiments the concentrate stream may be processed using a Mobile Processing System (MPS). FIG. 9 depicts an embodiment utilizing a Nanofilter skid 250 as a form of a conditioning step that is incorporated into the MPS configuration of FIG. 8. Some embodiments may comprise one or more Reverse Osmosis skids, Evaporation/Crystallization skids, and/or Nanofilter skids 250 for ion concentration. The configuration, type, and number of skids may vary between embodiments. The Nanofilter skid 250 is used for further embodiment descriptions as the example concentration method; however it should be noted that other concentration methods may be used. The Nanofilter skid 250 separates the source liquid into a permeate stream and a concentrate stream. The concentrate stream containing the greater concentration of multivalent species is sent to MPS, in the depicted embodiment. In some embodiments the permeate stream may be processed, stored, reused, or released to the environment depending on the types and concentrations of contaminants remaining in the liquid. In some embodiments the permeate stream may be processed by MPS.

In an embodiment one or more Solids Removal skids 220 may be used at one or more points in the system to reduce the possibility of any potential solids from fouling the systems. The number and location(s) of Solids Removal skids 220 required for a given embodiment is dependent on the suspended solids content in the process liquid. The level of suspended solids may be small in some embodiments because the inlet may be filled by decanting liquid from an evaporator collection tank. In some embodiments, the number of Solids Removal skids 220 may be as low as one or two when the MPS process does not include powder addition.

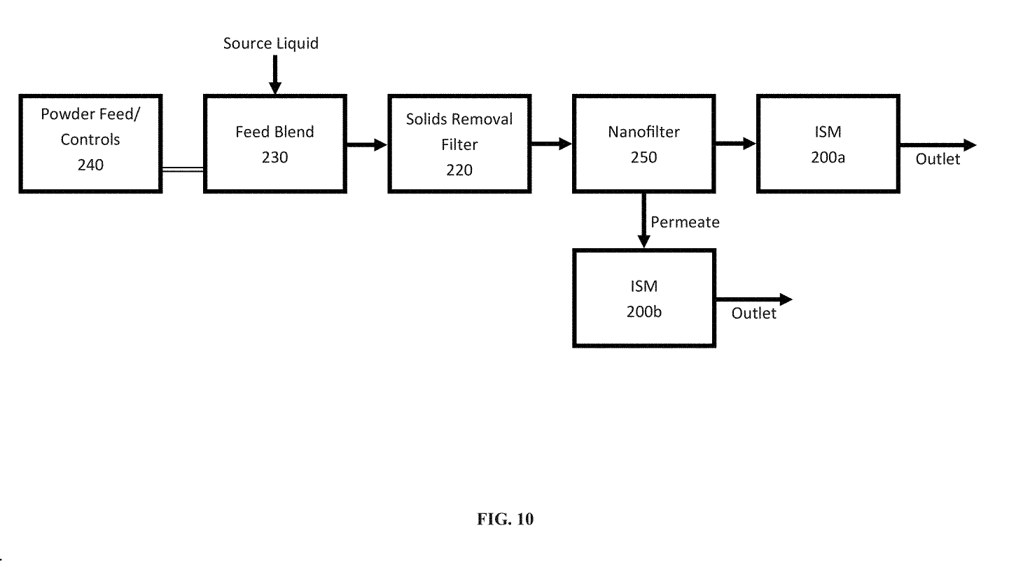

FIG. 10 depicts the embodiment of FIG. 9 wherein both the concentrate stream and permeate stream from the Nanofilter skid 250 proceed to an ISM skid (200a and 200b, respectively). The concentrate stream and the permeate stream will contain differing target species and concentrations thereof. Each ISM skid 200a and 200b is operable to remove one or more target species present in the stream it receives for processing.

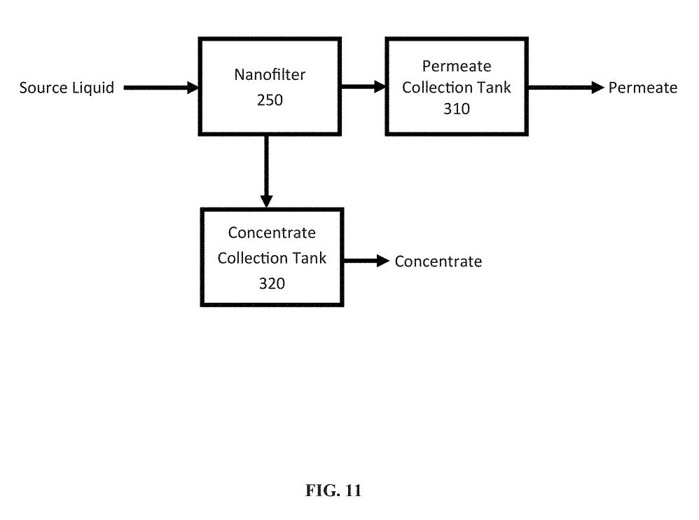

FIG. 11 depicts an embodiment that utilizes the Nanofilter skid 250 to process the source liquid into a Permeate Collection Tank 310 and Concentrate Collection Tank 320. In this embodiment, the filtered liquid containing the monovalent species is sent to the Permeate Collection Tank 310 while the concentrate stream containing the multivalent species is sent to the Concentrate Collection Tank 320. In some embodiments, one or both of the liquid streams exiting the Nanofilter skid 250 may be processed, stored, reused, or released to the environment depending on the types and concentrations of contaminants remaining in the liquid.

The liquid in the Concentrate Collection Tank 320 may be higher in target species concentration (compared to the source liquid concentration), which may improve the effectiveness of the media. Recirculation through the MPS skids and back to the Concentrate Collection Tank 320 may allow for more complete use of the media capacity. The projected chemistry for the Concentrate Collection Tank 320, in some embodiments, is not near the saturation point for one or more target species; therefore, solids are not expected from the concentration operation.

The projected composition of selected components in an embodiment for the Permeate Collection Tank 310 and Concentrate Collection Tank 320 is shown in Table 2, and an example of source liquid composition is provided for reference. A nanofilter system or skid may be designed to achieve 75% permeate recovery, in some embodiments.

TABLE 2
Projected Composition of Permeate and Concentrate Tanks

| | Source | Permeate | Concentrate |
|---|---|---|---|
| Component | Liquid | Tank, ppm | Tank, ppm |
| Calcium | 120 | 30 | 390 |
| Magnesium | 1400 | 145 | 5161 |
| Strontium | 3.7 | 0.9 | 11.8 |
| (total) | | | |
| Sodium | 5865 | 5671 | 6443 |
| Chloride | 12490 | 9333 | 21945 |

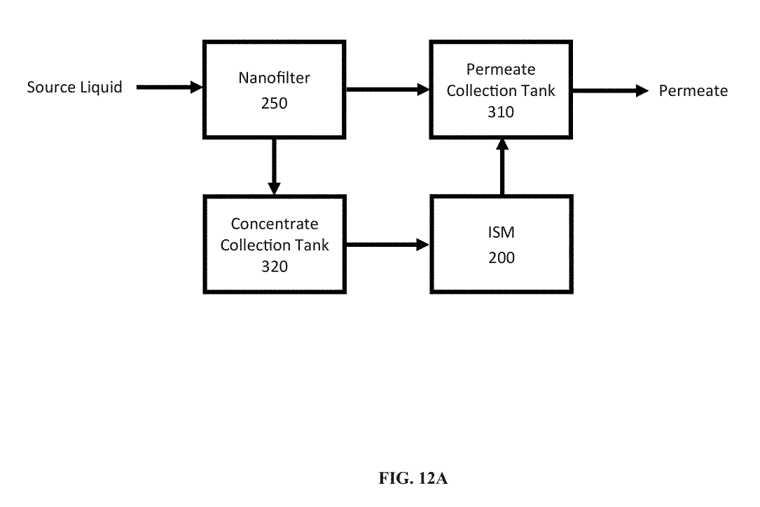

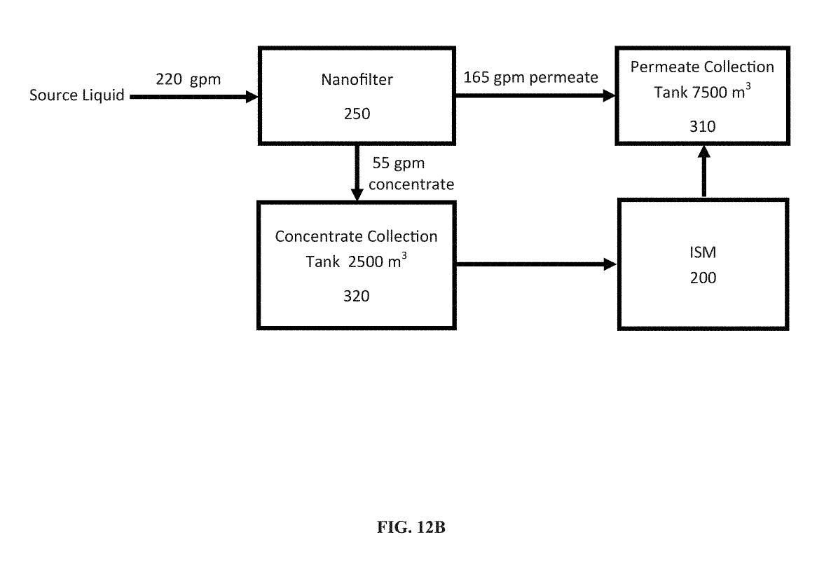

FIG. 12A depicts an embodiment that utilizes an ISM skid 200 to capture one or more target species from the concentrate stream. Since the amount of liquid to be processed is directly proportional to the amount of ion exchange media needed in some embodiments, the use of the Nanofilter skid 250 aids in reducing the amount of the liquid to be treated by filtering out the permeate stream that is sent to the Permeate Collection Tank 310, in the depicted embodiment; hence, maximizing the use of the ion exchange media and reducing the amount of ISM vessels needed. In some embodiments the concentrate stream may pass directly from the Nanofilter skid 250 to the ISM skid 200. In some embodiments the permeate stream may pass directly from the Nanofilter skid 250 to a separate ISM skid 200.

Some embodiments may utilize one or more of each skid. In some embodiments more than one concentration skid may be used wherein each concentration skid is used to concentrate a different particular target species. In some embodiments the system may comprise more than one ISM skid 200 wherein each ISM skid 200 may be specific to different particular target species. In some embodiments both the concentrate stream and the permeate stream may proceed to separate ISM skids 200 wherein each ISM skid 200 is operable to remove one or more particular target species present in each stream.

In some embodiments the source liquid may have been previously processed. In some embodiments the source liquid may have been previously processed for a different target species prior to processing in the depicted systems. In some embodiments the source liquid is a concentrate stream. In some embodiments the source liquid is a permeate stream. Some embodiments may comprise a series of Nanofilter skid 250 and ISM skid 200 pairs wherein each pair is operable to process a particular target species. In some embodiments the processed liquid exiting the ISM skid 200 may proceed through one or more systems of Nanofilter skid 250 and ISM skid 200 pairs wherein each pair is operable to process a different target species. In some embodiments the permeate stream may be stored in a Permeate Collection Tank 310, proceed directly to other processing or storage systems, or be released if it meets release standards.

FIG. 12B depicts the embodiment of FIG. 12A with example flow rates and tank volumes. In this example embodiment, a 7500 m³ Permeate Collection Tank 310 is used for receiving the permeate stream from the Nanofilter skid 250 while a 2500 m³ Concentrate Collection Tank 320 is used for receiving the concentrate stream. In the depicted embodiment, a source liquid may be supplied to the Nanofiltration skid 250 at 220 gpm; the permeate stream may be delivered to the Permeate Collection Tank 310 at 165 gpm while the concentrate stream may be delivered to the Concentrate Collection Tank 320 at 55 gpm. The same or similar flow rates may be applied to other configurations. Other embodiments may have different flow rates and tank volumes.

### Precipitation

Another alternate method of increasing ion exchange media capacity is precipitation. Precipitation is different than nanofiltration, reverse osmosis, and evaporation/crystallization in that it results in a concentrate stream containing the target species and one or more precipitated solids instead of a permeate stream. In an embodiment, a precipitation agent may be added to facilitate the extraction of one or more precipitants. Precipitation of one or more solids from solution increases the ratio of the remaining target species with respect to the precipitant species such that the driving force to reach equilibrium is increased by reducing the relative competition from the precipitant species. This increase in driving force results in more effective use of the ion exchange media thus increasing the capacity of the media.

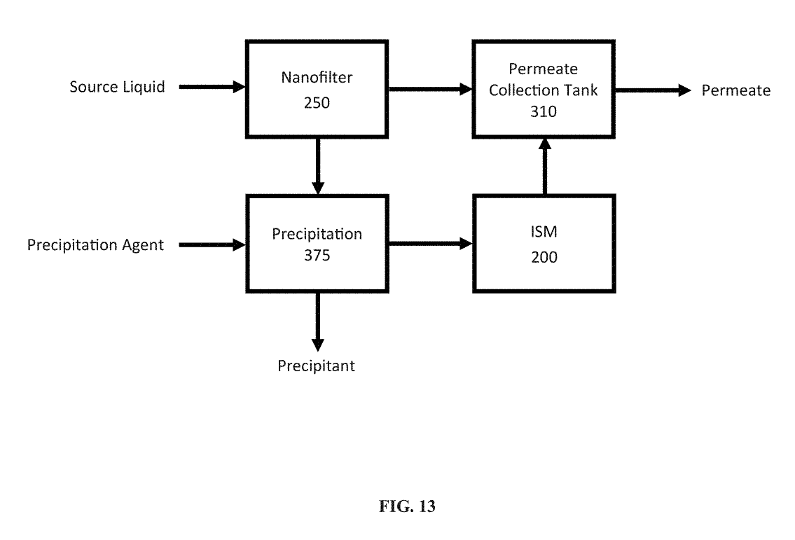

FIG. 13 depicts a generic embodiment of a precipitation process that involves the addition of a precipitation agent for the removal of one or more precipitant. In the depicted embodiment a Precipitation skid 375 follows a Nanofilter skid 250 prior to an ISM skid 200. In the depicted embodiment the permeate stream is routed to a Permeate Collection Tank 310. In some embodiments the permeate stream may be processed, stored, reused, or released to the environment depending on the types and concentrations of contaminants remaining in the liquid.

In an embodiment, the concentrations of one or more target species, such as magnesium, calcium, and strontium, in the concentrate stream can be significantly reduced with the use hydroxide precipitation. The difference in solubility and precipitation pH can be used to selectively extract and reduce the amount of one or more target species.

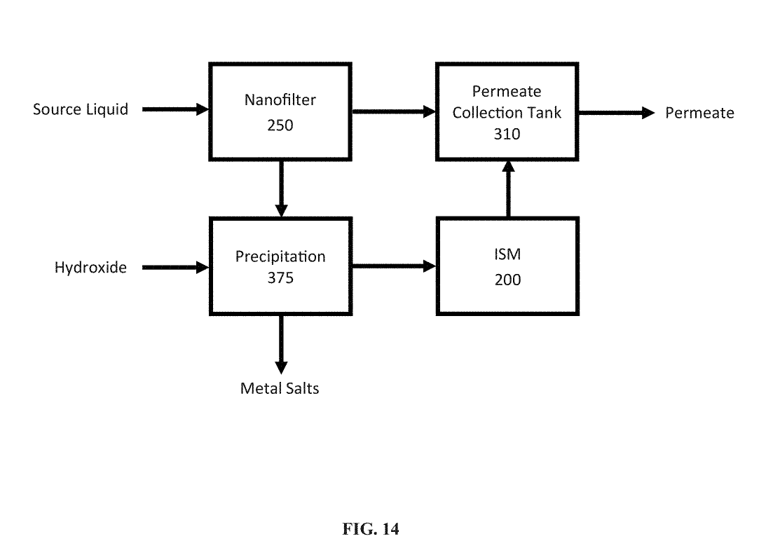

FIG. 14 depicts the precipitation process embodiment of FIG. 13 where the precipitation agent is a hydroxide. In the depicted embodiment hydroxide ions are introduced to the concentrate stream containing the metals to be extracted aiding in the precipitation of a target species such as magnesium, calcium, and/or strontium. Metals precipitate at various pH levels depending on the form of the metal, chemistry of the source liquid, and presence of other metals and chelates. As such the manipulation of the hydroxide ion concentration in the liquid adjusts the pH and readily precipitates the metals in form of metal hydroxide compounds. The pH level can be adjusted to target specific species. The pH may need to be carefully controlled because some metals are amphoteric in nature and the presence of chelating agents can also interfere with the ability for metals to precipitate.

The addition of a strong base such as sodium hydroxide may facilitate the formation of magnesium hydroxide, in some embodiments. In some embodiments magnesium hydroxide is the targeted precipitant though strontium hydroxide and calcium hydroxide may also form. Magnesium hydroxide is the more insoluble than strontium hydroxide and calcium hydroxide regardless of liquid temperature and has a lower precipitation pH of 9-10 so it is likely to precipitate first. Both strontium hydroxide and calcium hydroxide are slightly soluble in the same pH range as magnesium but most likely will not precipitate. An increase of the pH may result in the precipitation of strontium hydroxide and calcium hydroxide, since both have a solubility pH around 12.

The difference in the solubility of strontium hydroxide and calcium hydroxide can be used to selectively extract one from the other. This means that the relationship between solubility and temperature may be used to precipitate one while the other remains the liquid. The solubility of strontium hydroxide is directly proportional to temperature; hence, lowering the temperature of the liquid would decrease the solubility of strontium hydroxide and increase its precipitation rate. The solubility of calcium hydroxide is inversely proportional to temperature; hence, increasing the temperature of the liquid would decrease the solubility of calcium hydroxide and increase its precipitation rate.

Calcium hydroxide being more insoluble than strontium hydroxide would likely precipitate after magnesium hydroxide and before strontium hydroxide with an increase in pH of the stream to around 12, depending on temperature of the process liquid. An increase in temperature of the liquid may improve the efficiency of calcium hydroxide precipitation, while the strontium hydroxide becomes more soluble and remains in solution. In some embodiments the remaining strontium in solution may be concentrated in a nanofiltration step and removed in an ion exchange step.

In an embodiment, after the precipitation of magnesium hydroxide and calcium hydroxide, the concentrate stream may be cooled to facilitate the precipitation of the strontium hydroxide. Generally, the precipitation of strontium hydroxide occurs when the temperature of the solution is around 25° C. to 30° C. If the strontium hydroxide precipitation upon cooling isn't sufficient, carbon dioxide gas can be introduced into the solution to increase the efficiency of the strontium hydroxide precipitation.

In an embodiment, the advantage of using sodium carbonate and/or sodium hydroxide in the removal of magnesium, calcium, and strontium is that the remaining sodium in the liquid may be crystallized with the chlorides (as shown on Table 2) to form sodium chloride salt. The precipitants can then be recovered with the use of conventional processes such as filtering.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the systems, methods, processes, and/or apparatuses disclosed herein in a preferred embodiment thereof, it should be apparent that the systems, methods, processes, and/or apparatuses may be modified in arrangement and detail without departing from such principles. Claim is made to all modifications and variation coming within the spirit and scope of the following claims.

The embodiments in which an exclusive property or privilege is claimed are defined as follows:

1. A method for manipulating ion concentration to increase ion exchange media performance, the method comprising:
directing a liquid having a first concentration of ions through an ion concentrator operable to separate the liquid into a concentrate stream and a permeate stream;
directing the concentrate stream through a vessel, wherein the vessel contains an ion exchange media and is operable to:
receive the concentrate stream,
enable ion exchange between the ion exchange media and the concentrate stream resulting in a liquid having a second concentration of ions,
output the liquid having the second concentration of ions.

2. The method of claim 1, wherein the ion concentrator is at least one of a nanofilter, reverse osmosis membrane, and an evaporator.

3. The method of claim 1, wherein the ion concentrator is mounted on at least one of a skid, module, and container.

4. The method of claim 1, wherein the ion exchange media is at least one of an adsorbent media and absorbent media.

5. The method of claim 1, wherein the second concentration of ions is less concentrated than the first concentration of ions.

6. The method of claim 1, wherein a performance of the ion exchange media is based on an effective capacity of the ion exchange media.

7. The method of claim 1, wherein a first set of ions is concentrated to a first value, and a second set of ions is concentrated to a second value, wherein a removal performance of the first set of ions is increased when the second value is less than the first value.

8. The method of claim 7, wherein the removal performance of the first set of ions is decreased when the second value is greater than the first value.

9. The method of claim 1, wherein a performance of the ion exchange media is determined by an amount of waste produced.

10. The method of claim 1, wherein the ion exchange media approaches maximum theoretical capacity as the first concentration of ions increases.

11. A method for manipulating ion concentration to increase ion exchange media performance, the method comprising:
directing a liquid having a first concentration of ions through an ion concentrator operable to separate the liquid into a concentrate stream and a permeate stream;
directing the permeate stream through a vessel, wherein the vessel contains an ion exchange media and is operable to:
receive the permeate stream,
enable ion exchange between the ion exchange media and the permeate stream resulting in a liquid having a second concentration of ions,
output the liquid having the second concentration of ions.

12. The method of claim 11, wherein the ion concentrator is at least one of a nanofilter, reverse osmosis membrane, and an evaporator.

13. The method of claim 11, wherein the ion concentrator is mounted on at least one of a skid, module, and container.

14. The method of claim 11, wherein the ion exchange media is at least one of an adsorbent media and absorbent media.

15. The method of claim 11, wherein the second concentration of ions is less concentrated than the first concentration of ions.

16. The method of claim 11, wherein a performance of the ion exchange media is based on an effective capacity of the ion exchange media.

17. The method of claim 11, wherein a first set of ions is concentrated to a first value, and a second set of ions is concentrated to a second value, wherein a removal performance of the first set of ions is increased when the second value is less than the first value.

18. The method of claim 17, wherein the removal performance of the first set of ions is decreased when the second value is greater than the first value.

19. The method of claim 11, wherein a performance of the ion exchange media is determined by an amount of waste produced.

20. The method of claim 11, wherein the ion exchange media approaches maximum theoretical capacity as the first concentration of ions increases.
